(19) United States
(12) Patent Application Publication
(10) Pub. No.: US 2013/0285388 A1
(43) Pub. Date: Oct. 31, 2013

(54) Adjustable Safety Gate Lock

(71) Applicant: Jason David Bishop, Columbus, OH (US)

(72) Inventor: Jason David Bishop, Columbus, OH (US)

(73) Assignee: Jason David Bishop, Columbus, OH (US)

(21) Appl. No.: 13/456,219

(22) Filed: Apr. 26, 2012

(51) Int. Cl. E05C 19/18

(52) U.S. Cl. CPC E05C 19/18
USPC 292/1

(57) ABSTRACT

An adjustable safety gate lock which will prevent a locking bar arm on a wooden pressure mounted gate from being opened by a small child or a pet. The adjustable safety gate lock will go around the closed locking bar arm on the gate and will close shut with the side release buckle. Thereby preventing small children from opening the wooden pressure mounted gate by pulling the bar up and going into a restricted or dangerous area.

### CROSS-REFERENCE TO RELATED APPLICATIONS

“Not Applicable”

### DESCRIPTION

### BACKGROUND OF THE INVENTION

The present invention relates to safety gates as an impassable barrier to exclude passage of a small child or a pet thru the access way, but it is also necessary to provide for removal of the barrier to permit passage by an adult.

The safety gate that this present invention would benefit is the tall wooden pressure mounted gates. It can also be used on the shorter wooden pressure mounted safety gates. The adjustable safety gate lock invention would prevent the lock bar arm from being pushed up, therefore making it a stronger more secure barrier. The pressure mounted safety gates are also known as position and lock gates.

While the above described safety gates are generally satisfactory for preventing passage of small children or pets thru access ways, a number of shortcomings of such devices have been identified by the inventor. For example, although the safety gate has a locking bar it can be pushed up by either reaching over the gate or putting fingers through the mesh of the gate and lifting up the bar.

### BRIEF SUMMARY OF THE INVENTION

With the invention it will lock the gate bar arm securely into place therefore preventing the safety gate from being opened by a small child or pet. The adjustable safety gate lock mostly consists of nylon webbing, a plastic side release buckle, a metal washer and a pop rivet. The above-mentioned invention is put on by wrapping it around the closed lock bar arm. The metal rivet side goes into the groove of the wood on the arm of the closed bar, whereby the metal washer will be flat against the nylon webbing. When the invention is wrapped over the gate bar arm it will close with the adjustable side release buckle.

The invention will be able to be opened by an adult by squeezing the side release buckle open on the adjustable safety gate lock and then lifting up the locking gate bar arm. The invention is made small so it will be very difficult for a child to be able to reach over and open it, likewise it would be nearly impossible for a child to reach through the gate mesh and open the side release buckle. The above-mentioned invention is adjustable so it will be able to wrap around and fit the standard (approx. 23.8 inches high) wooden pressure mounted gates and the tall (approx. 32.7 inches high) wooden pressure mounted gates currently on the market.

### BRIEF DESCRIPTION OF THE SEVERAL VIEWS OF THE DRAWING

FIG. 1 is a view of the top of the adjustable safety gate lock opened flat.

FIG. 2 is a back view of the adjustable safety gate lock opened flat.

FIG. 3 is a side view of the adjustable safety gate lock opened on its side.

### DETAILED DESCRIPTION OF THE INVENTION

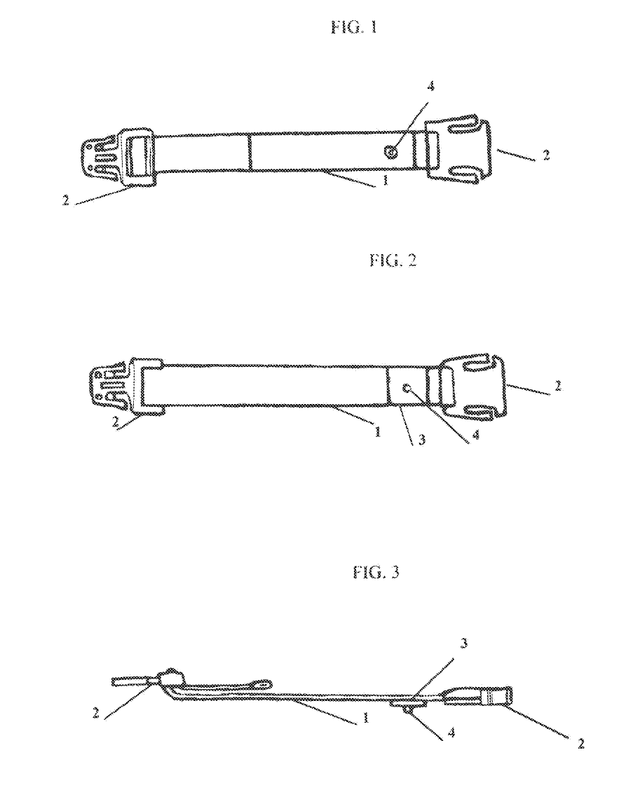

The adjustable safety gate lock will prevent a small child or pet from opening the several types of wooden pressure mounted gates. The invention is made from a piece of nylon webbing 1 approx. 6 inches long and ½ inch wide. Then an adjustable side release buckle 2 is opened and the nylon webbing 1 is sewn to one side of the adjustable side release buckle 2 and the other end of the nylon webbing 1 is put thru the opposing side of the adjustable side release buckle 2. The nylon webbing 1 can be any color. The adjustable side release buckle 2 is generally all black in color. There is a ½ inch metal washer 3 pop riveted 4 to the one end of the nylon webbing 1 as shown in FIG. 1, FIG. 2 and FIG. 3.

FIG. 1 shows the back of the pop rivet 4 which is 4/32 wide. FIG. 1 also shows the front side of the adjustable safety gate lock opened flat. FIG. 1 also includes the nylon webbing 1 attached to either side of the side release buckle 2. FIG. 2 shows the front of the pop rivet 4 sticking up a little. This is the side that will go into the groove against the safety gate wooden locking bar. The pop rivet 4 will fit right into the groove of the locking gate bar. FIG. 2 also shows the ½ inch metal washer 3, the back of the nylon webbing 1 opened flat and the side release buckle 2 on both ends. FIG. 3 shows the invention on its side opened flat with the pop rivet 4 and the metal washer 3 shown clearly. FIG. 3 also shows the side of the nylon webbing 1 and the side release buckle 2 on both ends.

When the adjustable safety gate lock is closed into place it will be nearly impossible for a small child to stick their hand thru the webbing of the gate and lift of the closed locking bar. The invention will open by pushing on both sides of the adjustable side release buckle 2.

What I claim is:

1. An adjustable safety gate lock that will prevent a safety gate from being opened by pulling up or pushing from the opposing side of the gate on the closed handle lock bar.

2. An adjustable safety gate lock according to claim 1, wherein the invention will wrap around the closed lock bar arm of the gate and lock into place using the side release buckle.

3. An adjustable safety gate lock according to claim 1, where in it's made from mostly nylon webbing, an adjustable side release buckle, a metal square washer and a pop rivet.
